(19) United States
(12) Patent Application Publication
(10) Pub. No.: US 2008/0120507 A1
(43) Pub. Date: May 22, 2008

(54) METHODS AND SYSTEMS FOR AUTHENTICATION OF A USER

(76) Inventor: Rajesh G. Shakkarwar, Cupertino, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/668,541

(22) Filed: Jan. 30, 2007

Related U.S. Application Data
(63) Continuation-in-part of application No. 11/562,353, filed on Nov. 21, 2006.

(51) Int. Cl. H04K 1/00

(52) U.S. Cl. 713/182

(57) ABSTRACT

The present invention generally relates to a computer security system for use in the authentication of a user prior to setting up an on-line account. In one aspect, a method for authenticating a user in a system configured to identify and authenticate the user is provided. The method includes prompting the user to answer at least one initial question. The method further includes obtaining data about the user from a data source based on the answer to the at least one initial question. The method also includes reviewing the data from the data source and generating at least one specific personal question based on the data from the data source. Additionally, the method includes prompting the user to answer the at least one specific personal question and verifying the answer to the at least one specific personal question.

### CROSS-REFERENCE TO RELATED APPLICATIONS

This application is a continuation-in-part of co-pending U.S. patent application Ser. No. 11/562,353, filed on Nov. 21, 2006, which is herein incorporated by reference.

### BACKGROUND OF THE INVENTION

1. Field of the Invention

The present invention generally relates to computer security and more specifically to methods and systems for identifying and authenticating a user.

2. Description of the Related Art

Internet commerce has increased dramatically over the last several years. As a result, many companies or institutions have created websites that allow customers to access personal account information via the Internet. For instance, banks may allow a customer to perform routine transactions, such as account transfers, balance inquiries, bill payments, and stop-payment requests from a remote computer. In addition, some banks allow their customers to apply for loans and credit cards on-line as well.

To set up an account with the company or institution, the person will typically go to a branch office in order to go through an authentication process and fill out the necessary paperwork. The authentication process is used to establish or confirm the person is authentic by verifying their identity. The identity of the person is typically verified by the person visiting the branch office and showing some form of picture ID. Although this type of authentication process is effective, this process may be problematic if the company or institution does not have a branch office that is convenient for the person to visit.

The authentication process is even more problematic for an on-line company or institution that only has an Internet presence because the on-line company or institution does not have a branch office that the person can visit in order to verify their identity. In this situation, the on-line company or institution must authenticate the user by asking the person standard identification questions, such as “what is the person's birthday, social security number, or mother's maiden name”. However, the answers to these standard identification questions may be easily stolen or obtainable via the Internet. As a result, an account may be set-up with the on-line company or institution by a person who has the answer to the standard identification questions but is not the real owner of that identity. This unlawful use of a person's identity is a common form of identity theft.

As the foregoing illustrates, there is a need in the art for a way to authenticate the identity of on-line customers that is more secure than current approaches.

### SUMMARY OF THE INVENTION

The present invention generally relates to a computer security system for use in the authentication of a user prior to setting up an on-line account. In one aspect, a method for authenticating a user in a system configured to identify and authenticate the user is provided. The method includes prompting the user to answer at least one initial question. The method further includes obtaining data about the user from a data source based on the answer to the at least one initial question. The method also includes reviewing the data from the data source and generating at least one specific personal question based on the data from the data source. Additionally, the method includes prompting the user to answer the at least one specific personal question and verifying the answer to the at least one specific personal question.

In another aspect, a computer-readable medium including a set of instructions that when executed by a processor causes the processor to authenticate a user in a system configured to identify and authenticate the user is provided. The processor performs the step of prompting the user to answer at least one initial question. The processor also performs the step of obtaining data about the user from a data source based on the answer to the at least one initial question. Further, the processor performs the step of reviewing the data from the data source and generating at least one specific personal question based on the data from the data source. Additionally, the processor performs the step of prompting the user to answer the at least one specific personal question and verifying the answer to the at least one specific personal question.

In yet a further aspect, a system for authenticating a user is provided. The system includes a user machine. The system further includes a server machine having a processor and a memory, wherein the memory includes a program configured to prompt the user via the user machine to answer at least one initial question. The server machine is also configured to obtain data about the user from a data source based on the answer to the at least one initial question. The server machine is further configured to review the data from the data source and generate at least one specific personal question based on the data from the data source. Additionally, the server machine is configured to prompt the user via the user machine to answer the at least one specific personal question and verify the answer to the at least one specific personal question.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual block diagram of a system configured to authenticate the identity of a user, according to one embodiment of the invention.

FIG. 2 is a flow chart of method steps for authenticating the identity of a user, according to one embodiment of the invention.

### DETAILED DESCRIPTION

In general, the invention relates to a computer security system for use in the authentication of a user prior to setting up an on-line account. The system will be described herein in relation to a single user. However, it should be understood that the systems and methods described herein may be employed with any number of users without departing from the principles of the present invention. To better understand the novelty of the system of the present invention and the methods of use thereof, reference is hereafter made to the accompanying drawings.

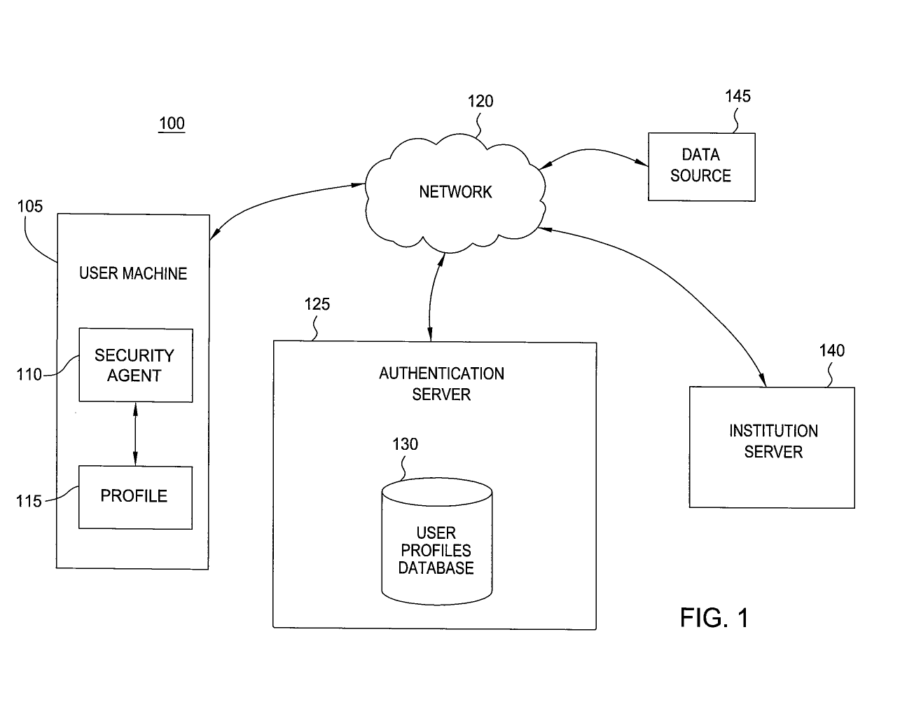

FIG. 1 is a conceptual block diagram of a system configured to authenticate the identity of a user, according to one embodiment of the invention. The system 100 includes a user machine 105, which may be any type of individual computing device such as, for example, a desk-top computer, a lap-top computer, a hand-held phone device, or a personal digital assistant. Generally, the user machine 105 is configured to be a communication link between the user and the other components in the system 100.

The system 100 further includes a network 120, which may be any type of data network, such as a local area network (LAN), a metropolitan area network (MAN), a wide area network (WAN), or the Internet. The network 120 is configured to act as a communication pathway between the user machine 105, an authentication server 125, an institution server 140, and a data source 145.

The authentication server 125 interacts with the user machine 105 and the institution server 140 via the network 120 during the authentication procedure, as described below. The institution server 140 stores sensitive information for the user e.g., financial account information, confidential data, etc. The institution server 140 may be part of a bank, a building society, a credit union, a stock brokerage, or other businesses holding sensitive data.

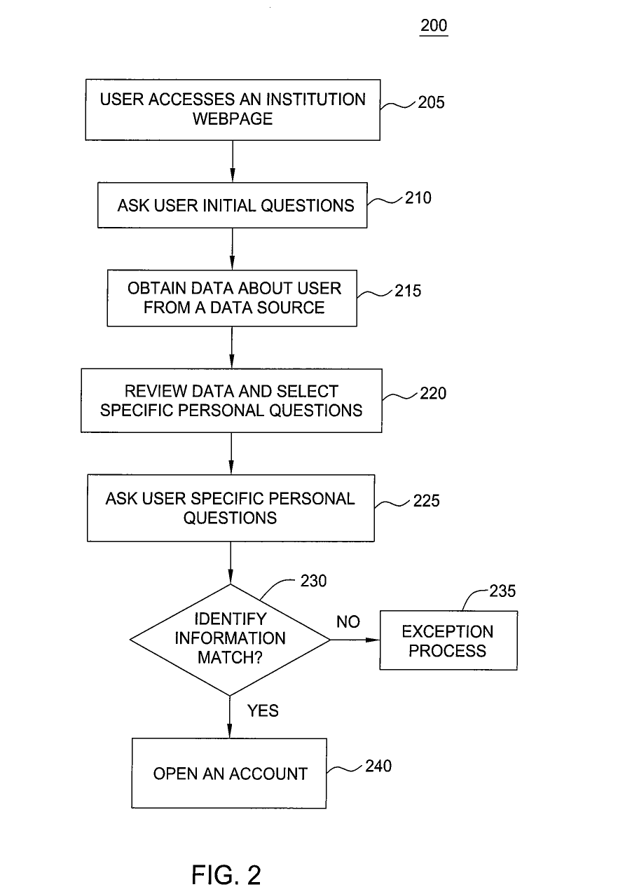

FIG. 2 is a flow chart of method steps for authenticating the identity of a user, according to one embodiment of the invention. Although the method steps are described in the context of the system of FIG. 1, any system configured to perform the method steps, in any order, is within the scope of the invention. Generally, the authentication process 200 is an iterative process used to verify the identity of the user. As will be discussed herein, verifying the user identity during the authentication process 200 may include having the user answer an initial set of questions and subsequently answer a set of more specific personal questions, e.g., previous employer, information on a previously owned vehicle, previous residential address, etc. The answers are checked against a known answer from the data source 145, such as a third party consumer data base, to verify that the user is who the user claims to be. After the authentication process 200 is complete, the user is able to open an account at the institution or download a security agent in order to perform a secure access transaction, as described in U.S. patent application Ser. No. 11/562,353, which is incorporated herein by reference. The process of verifying the identity of the user in this fashion significantly reduces the chance of identity theft by a malicious third party claiming to be the user.

The authentication process 200 begins in step 205, where the user accesses a webpage at the institution. Generally, the webpage is configured to educate the user about the process of opening an account with the institution and subsequently start the user authentication process of step 210. In one embodiment, the webpage is generated by the institution server 140 and downloaded to the user machine 105 when the user attempts to open an account with the institution.

In step 210, the user is asked initial questions in order to start the process of authenticating the user and generating an initial user identity. The questions may relate to standard identity questions, such as “what is the birthday of the user,” “what is the social security number of the user” and/ or “what is the mother's maiden name of the user.” The answers to the questions are used in step 215 to obtain additional data about the user from one or more data sources.

In step 215, data is obtained from the data source 145 after the initial identity of the user is established. The data is specific information about the user. In one embodiment, the data source 145 is a third party database. In another embodiment, the data source 145 is the institution.

In step 220, the more specific data about the user is reviewed and specific personal questions are generated. In this step, in one embodiment, the authentication server 125 analyzes the data and generates a series of specific personal questions. The specific personal questions may relate to static data about the user that does not change, such as “what car did you drive before your current car,” “what was your telephone number before your current telephone number” or “what address did you live at before your current address.” If the data source 145 is the institution, then the specific questions may relate to dynamic data about the user that frequently changes and is known only by the institution, such as “when was your last deposit,” “what was the last check number,” “who was the check written to” or “who last deposited money in the financial institution”, “or what was your last take home pay amount.” In either case, the specific personal questions are generated to further authenticate the user.

In step 225, the user is asked the specific personal questions. In step 230, the answers given by the user are compared to known answers from the data received from the data source 145 to verify the identity of the user. If the answers given by the user match the known answers, then, in step 240, the user is allowed to open an account with the institution. If the answers do not match the known answers in the data source 145, then, in step 235, an exception process is activated. The exception process may include a verification of the user over the phone. Additionally, the exception process may include the user making a personal appearance at a specific location. The exception process in step 235 may be any type of process known in the art to verify the identity of the user.

The method steps of the authentication process 200 are described in a general manner in the context of the system of FIG. 1. It should be understood, however, that the steps may be performed by the authentication server 125, the institution server 140, a separate server, or combinations thereof. For instance, in one embodiment, the user may access the institution server 140 to open an account, and the institution server 140 may transfer the relevant information to the authentication server 125. In this embodiment, the authentication server handles the interactive authentication process 200 and then transfers control back to the institution sever 140 to open the account after the authentication process is complete. In another embodiment, the institution sever 140 handles a portion of the authentication process 200, and the authentication server 125 handles a portion of the authentication process 200. For instance, the institution sever 140 may ask the user the initial set of questions and then transfer the answers to these questions to the authentication server 125 in order to obtain the data from the data source 145, review the data, and generate the more specific set of personal questions. Then, the authentication server 125 may transfer the specific personal questions and the known answers to the institution sever 140 to complete the authentication process 200. Again, the method steps may be performed by any system, in any order, without departing from principles of the present invention.

After the user is authenticated by the authentication process 200, a verified user identity is created and the user is allowed to open an account at the institution, as set forth in step 240. The user may also have the option to download a security agent 110, thereby allowing the user the capability of performing a secure access transaction or a secure payment transaction as described in U.S. patent application Ser. No. 11/562,353, which is incorporated herein by reference.

The security agent 110 is downloaded to the user machine 105 after the identity of the user is established. In one embodiment, the security agent 110 is downloaded directly from the institution server 140 via the network 120. In another embodiment, the security agent 110 is downloaded via the network 120 from the authentication server 125. In any case, the security agent 110 is configured to interact with both the authentication server 125 and the institution server 140.

After the security agent 110 is downloaded, a user name and password is selected to establish a first factor of authentication. In one embodiment, the user selects the user name and password. In another embodiment, the authentication server 125 or the institution sever 140 generates the user name and/or the password. In any case, the user name and/or password are used during the secure access transaction and the secure payment transaction.

After the first factor of authentication is established, unique information from the user machine 105 is extracted by the security agent 110 to establish the second factor of authentication. The information may include any number of different types of data associated with the user machine 105. For instance, the information may include the IMEI or the IMSI which relate to mobile devices. The information may include the geolocation of the user machine 105. The information may also include machine level attributes, such as a Device ID, a Vendor ID, data at a SMM memory space, a memory type, a memory clock speed, hard drive serial number, chipset information, data at different locations in firmware, information available in Microcode patch, a checksum of firmware, or BIOS. Further, the information may include system level attributes, such as a MAC address, a hard drive serial number, interrupt routing, GPIO routing, PCI DevSel routing, a map of hardware configuration, or an operating system registry. Additionally, the information may relate to system pattern extraction, such as a directory structure or a list of installed applications. No matter what type of select data is extracted from the user machine 105, the data or a combination of dfferent types of data should be unique to the user machine 105 in order to establish the second factor of authentication.

After the second factor of authentication is established, biometric information is collected in order to establish the third factor of authentication. The biometric data may include specific typing patterns of the user or biometric data generated by a biometric device, such as a fingerprint device or an iris pattern device. Although three factors of authentication were discussed herein, it should be understood, however, that any of the factors may be an optional factor without departing from principles of the present invention.

After the factors of authentication are established, the verified user identity from steps 205-230 is connected (or bound) to a user identity profile 115 which generally comprises the data collected in the establishment of the factors of authentication. The connecting (or binding) of the verified user identity to the factors of authentication allows the user to engage in the secure access transaction or the secure payment transaction without having to repeat a portion of the authentication process 200. In other words, the binding of the identity with the factors of authentication eliminates the cumbersome process of proving the identity of the user at every transaction, while providing the same level of security as though the user answered the identity questions (the specific personal questions) every time.

A copy of the profile 115 is stored in the user profiles database 130 in the authentication server 125. During the secure access transaction and the secure payment transaction, the security agent 110 interacts with the authentication server 125 by comparing the data from the user and the user machine with the user profile 115 stored in the user profiles database 130 to establish the identity of the user before proceeding with the transaction.

While the foregoing is directed to embodiments of the present invention, other and further embodiments of the invention may be devised without departing from the basic scope thereof, and the scope thereof is determined by the claims that follow.

I claim:

1. A method for authenticating a user in a system configured to identify and authenticate the user, the method comprising:
prompting the user to answer at least one initial question;
obtaining data about the user from a data source based on the answer to the at least one initial question;
reviewing the data from the data source and generating at least one specific personal question based on the data from the data source;
prompting the user to answer the at least one specific personal question; and
verifying the answer to the at least one specific personal question.

2. The method of claim 1, wherein the data source is a third party data base or an institution data base.

3. The method of claim 1, further comprising opening an account at an institution after the answer to the at least one specific personal question is verified.

4. The method of claim 1, wherein verifying the answer comprises comparing the answer to the at least one specific personal question to a known answer.

5. The method of claim 4, wherein the known answer is determined from the data from the data source

6. The method of claim 1, further comprising creating a verified user identity after the answer to the at least one specific personal question is verified.

7. The method of claim 1, further comprising downloading a security agent to a user machine after the answer to the at least one specific personal question is verified.

8. The method of claim 1, further comprising activating an exception process when the answer to the at least one specific personal question does not match a known answer.

9. The method of claim 8, wherein the exception process includes a telephone conversation with the user.

10. A computer-readable medium including a set of instructions that when executed by a processor cause the processor to authenticate a user in a system configured to identify and authenticate the user by performing the steps of:
prompting the user to answer at least one initial question;
obtaining data about the user from a data source based on the answer to the at least one initial question;
reviewing the data from the data source and generating at least one specific personal question based on the data from the data source;
prompting the user to answer the at least one specific personal question; and
verifying the answer to the at least one specific personal question.

11. The computer-readable medium of claim 10, further comprising creating a verified user identity after the answer to the at least one specific personal question is verified.

12. The computer-readable medium of claim 11, wherein the user is allowed to open an account at an institution based upon the verified user identity.

13. The computer-readable medium of claim 11, wherein the user is allowed to download a security agent to a user machine based upon the verified user identity.

14. The computer-readable medium of claim 10, wherein the data source is a third party data base or an institution data base.

15. A system for authenticating a user, the system comprising:
a user machine; and
a server machine having a processor and a memory, wherein the memory includes a program configured to:
prompt the user via the user machine to answer at least one initial question;
obtain data about the user from a data source based on the answer to the at least one initial question;
review the data from the data source and generate at least one specific personal question based on the data from the data source;
prompt the user via the user machine to answer the at least one specific personal question; and
verify the answer to the at least one specific personal question.

16. The system of claim 15, wherein the data source is a third party data base or an institution data base.

17. The system of claim 15, wherein a verified user identity is created after the answer to the at least one specific personal question is verified.

18. The system of claim 17, wherein the user is allowed to open an account at an institution based upon the verified user identity.

19. The system of claim 17, wherein the user is allowed to download a security agent to the user machine based upon the verified user identity.

20. The system of claim 15, wherein an exception process is activated when the answer to the at least one specific personal question does not match a known answer.
